(19) United States
(12) Patent Application Publication
(10) Pub. No.: US 2013/0151347 A1
(43) Pub. Date: Jun. 13, 2013

(54) Structured Questions in a Social Networking System

(71) Applicants: Robert Michael Baldwin, San Francisco, CA (US); Adrian A. Graham, San Francisco, CA (US); Drew W. Hamlin, San Francisco, CA (US)

(72) Inventors: Robert Michael Baldwin, San Francisco, CA (US); Adrian A. Graham, San Francisco, CA (US); Drew W. Hamlin, San Francisco, CA (US)

(21) Appl. No.: 13/316,346

(22) Filed: Dec. 9, 2011

(51) Int. Cl. G06F 15/16; G06F 3/048; G06Q 30/02

(52) U.S. Cl. 705/14.66; 709/204; 715/810; 715/843; 715/821

(57) ABSTRACT

A social networking system includes a question and answer system that allows questions to be associated with social networking system objects. A question is received from a questioning user. A question term is identified, and an object associated with the question term is identified. The identified object is then associated with the question, and this association is stored. Question terms can be identified by the questioning user, or automatically, using contextual information. Question objects may also be identified by using template questions or sample questions provided by the social networking system. The stored association may be used to collection information about answering users, to auto-populate answers, and to generate social networking system stories. The stored association may also be used to collect information about the object of the stored association, to recommend an object to a user, to target advertising to users, and to recommend answers to users.

### CROSS REFERENCE TO RELATED APPLICATIONS

This application is related to U.S. patent application Ser. No. 13/070,475, filed Mar. 24, 2011; U.S. patent application Ser. No. 13/070,476, filed Mar. 24, 2011; and U.S. patent application Ser. No. 13/070,477, filed Mar. 24, 2011. The content of these applications is hereby incorporated by reference in their entirety.

### BACKGROUND

This invention relates generally to social networking and, in particular, to associating questions asked within a social networking system with social networking system objects.

Traditional question and answer software systems use a search interface that links into a set of documents that discuss various topics for answering users' questions. For example, a question entered by a user is searched using natural language processing systems to retrieve documents that answer the question. Often, the documents that are presented to the user do not specifically answer the question entered, and instead they simply offer an encyclopedic explanation of the general topic of the question. User-generated content question and answer systems have emerged in recent years to address this problem. In these systems, a user posts a question to a forum, and one or more other users answer the question. The asking and answering of questions in such systems, however, is inflexible and lacks social context.

### SUMMARY

Embodiments of the invention provide a method for associating questions in a social networking system with social networking system objects. A question is received at a social networking system from a questioning user, for instance through a question interface. A question term is identified in the received question. The question term may be a word or a phrase within the text of the received question. An object associated with the identified question term is identified, and the identified object is associated with the received question. The association between the received question and the identified object is then stored for subsequent use.

The identified question term and associated identified object may be selected by a questioning user. The questioning user may select one of the question terms, and the social networking system may display a list of objects determined to be relevant to the question term. The questioning user may then select a displayed object, or may select another object other than those displayed. Alternatively, the social networking system may automatically identify a question term and may identify an object associated with the question term using, for example, the context of the question term in the question, information associated with the questioning user, or any other information related to the question.

In one embodiment, the social networking system presents question templates to a questioning user, and the user selects a question template. The question templates may include one or more blank spaces, each associated with one or more sample question terms for selection by the questioning user. Each sample question term is pre-associated with an object. Alternatively, the questioning user may provide a question term in each blank space, and may manually associate provided question terms with objects. In an alternative embodiment, the social networking system presents sample questions for selection by a questioning user, each sample question including one or more question terms pre-associated with objects.

The stored association may be used by the social networking system for a variety of purposes. The social networking system may use the stored association to collect information about users who answer the received question, which in turn may be used to auto-populate social networking system forms associated with the answering users. The stored association may be used to generate news stories for display in a newsfeed or news ticker. The stored association may be used to recommend a social networking system object to a user, or to target advertising to a user. The social networking system may also use the stored association to collect information associated with the identified object, to recommend an answer to a user, and to identify objects associated with answers.

The figures depict various embodiments of the present invention for purposes of illustration only. One skilled in the art will readily recognize from the following discussion that alternative embodiments of the structures and methods illustrated herein may be employed without departing from the principles of the invention described herein.

### BRIEF DESCRIPTION OF THE DRAWINGS

FIG. 1 is a high-level block diagram illustrating the creation and display of question and answer data in a social networking system, in accordance with an embodiment of the invention.

FIG. 2 is a network diagram of a system for associating questions with social networking system objects, in accordance with an embodiment of the invention.

FIG. 3 is an example screenshot illustrating the display of a question associated with social networking system objects, in accordance with an embodiment of the invention.

FIG. 4 is an example screenshot illustrating a question interface in a social networking system for associating a question with social networking system objects, in accordance with an embodiment of the invention.

FIG. 5 is a flowchart of a process for associating one or more social networking system objects with a question asked in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Connected users are said to be “friends” in the context of the social networking system. Social networking systems comprise a series of interconnected pages, which may be displayed in a web browser or native application on a client device. Users of a social networking system can provide information describing themselves which is stored and displayed in pages called user profiles. For example, a user can provide age, gender, geographical location, education history, employment history and similar information describing the user. The information provided by users may be used by the social networking system to direct information to the user. For example, the social networking system may recommend social groups, events, and potential friends to a user.

Social networking system information that is tracked and maintained by a social networking system may be stored as a social graph, which includes a plurality of nodes that are interconnected by a plurality of edges (representing interactions, connections, communications or other measures of relatedness between nodes). A social graph node may represent a social networking system object that can act on and/or be acted upon by another node. An edge between nodes in a social graph represents any kind of connection or interaction between the two nodes, which may result from an action that was performed by one of the nodes on the other node. For example, two friends or otherwise connected users in a social networking system may be represented by nodes in the social graph, which may be connected by an edge representing the friendship within the social networking system. Likewise, a user may use a device with location-detection functionality (such as a mobile phone with GPS functionality) to “check in” to a real-world location (such as a dance club); the user and the dance club may each be represented by nodes in the social graph which may be connected by an edge representing the user's presence at the dance club in the real world.

A social networking system object may be a social networking system user, non-person entity, content item, group, social networking system page, location, application, concept or user interest item, such as a movie, a band, or a book. Content items may be anything that a social networking system user or other object may create, upload, edit or interact with, such as messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files. Social graph data, such as object data, user data and interaction data, is stored in social graph data storage module 165. In one embodiment, question data storage module 155, answer data storage module 160, and social graph data storage module 165 comprise the same storage module.

A question and answer service on a social networking system can use the tools and features of the social networking system to improve the performance and utility of the question and answer service. For example, a question and answer service may use a social networking system's social graph to associate social networking system objects with questions. When a user enters a question phrase in a social networking system, the social networking system may identify one or more objects associated with the question terms, and may connect the node representing each object to the node representing the question. Connecting a node representing a question to one or more object nodes is referred to herein as “associating” the question to the objects, or as “tagging” the objects to the question or one or more question terms. As used herein, the term “question term” refers to any word, phrase, concept, or text grouping within the question phrase. Associating a question to one or more objects allows users of a social networking system to receive a more personalized and useful experience from a question and answer service on a social networking system.

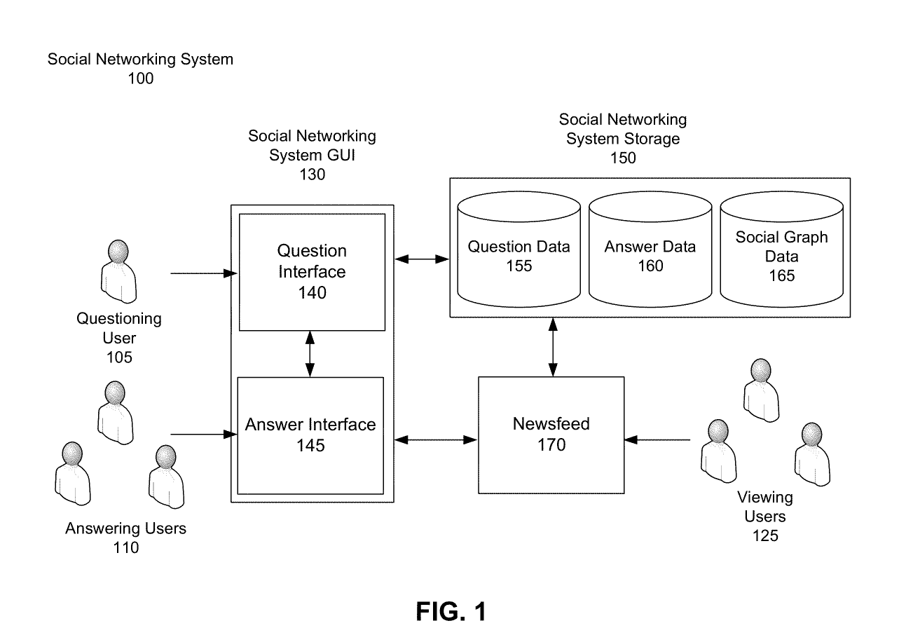

FIG. 1 is a high-level block diagram illustrating the creation and display of question and answer data in a social networking system, in accordance with an embodiment of the invention. The social networking system 100 comprises a social networking system graphical user interface (GUI) 130 for displaying a question and answer service. The social networking system GUI 130 may be used for all social networking system pages, or may be customized for a question and answer service. The social networking system GUI 130 comprises a question interface 140 and an answer interface 145. Question interface 140 and answer interface 145 may comprise the same interface, though for clarity, the functionalities of each are discussed separately below.

Questions and answers may be represented by nodes in the social graph, and may be connected to each other, to questioning user 105, to answering users 110, to viewing users 125, and to any other social networking system node. Questions, objects associated with questions in the social graph, and interactions represented by edges connected to questions in the social graph are referred to as “question data.” Answers, objects associated with answers in the social graph, and interactions represented by edges connected to answers in the social graph are referred to as “answer data.” Question data may be stored in question data storage module 155, and answer data may be stored in answer data storage module 160.

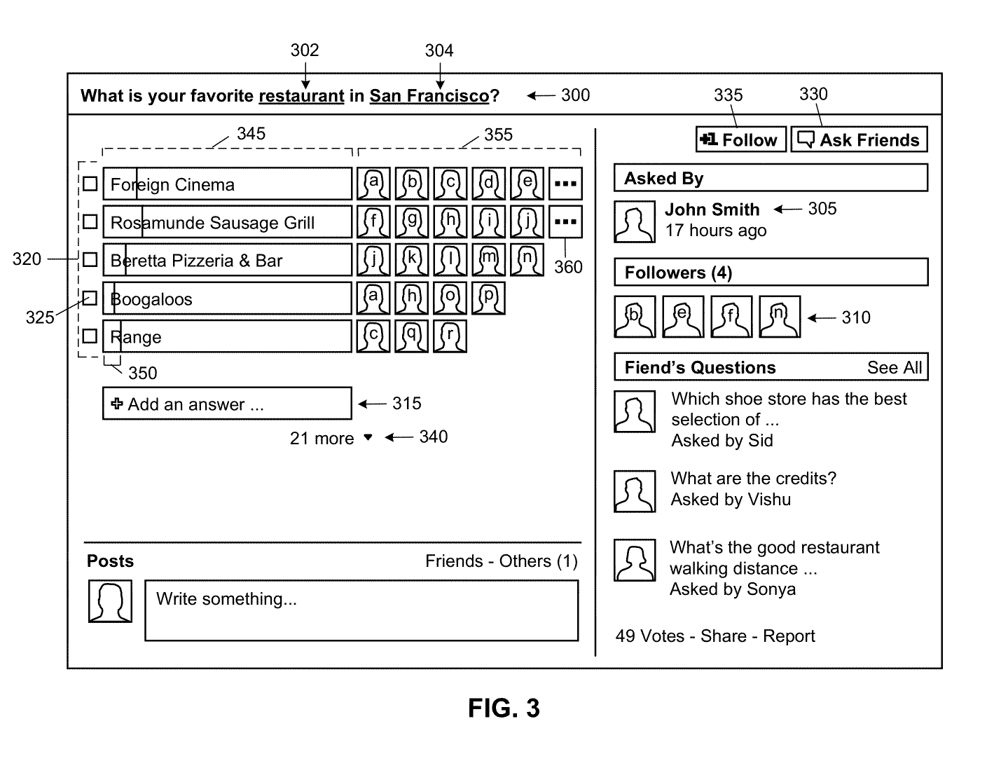

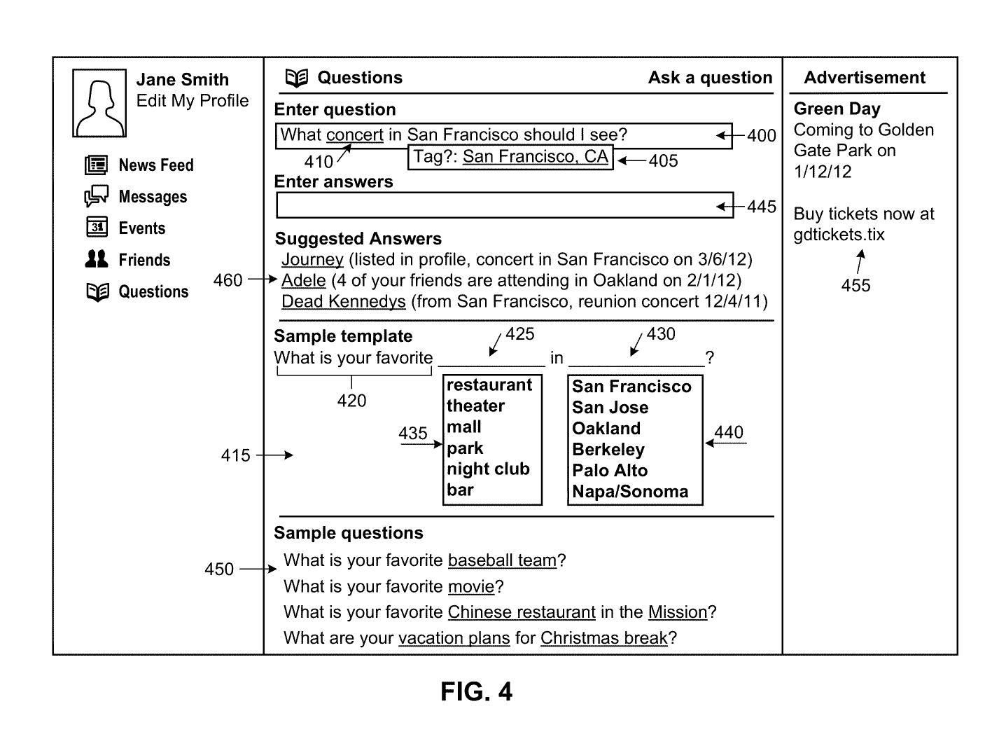

FIG. 3 is an example screenshot illustrating the display of a question associated with social networking system objects, in accordance with an embodiment of the invention. FIG. 4 is an example screenshot illustrating a question interface in a social networking system for associating a question with social networking system objects, in accordance with an embodiment of the invention. Description of the association of questions with social networking system objects herein will be made in conjunction herein with the example embodiments of FIGS. 3 and 4 for the purposes of clarification and simplicity.

### Question Interface

A questioning user 105 uses question interface 140 to ask a question to users of social networking system 100. The question interface 140 may be graphically rendered on the social networking system 100 in various locations to encourage users to use the question and answer service. In one embodiment, for example the embodiment of FIG. 4, question interface 140 comprises a dedicated social networking system page. Alternatively, question interface 140 may appear in a portion of another social networking system page, such as in a margin of a user profile. A user may add a tab or a button in a social networking system GUI 130 which may be clicked to display the question interface 140.

Question interface 140 may comprise a field in which questioning user 105 may enter and submit a question. For example, the interface of FIG. 4 includes field 400 in which a user may enter a question. Various types of questions may be posed, viewed, and answered by users of the social networking system using the question interface 140. Polling questions may be asked by a questioning user 105 to see various percentages of responding users, such as the questions “Should Don't Ask and Don't Tell legislation be repealed?” and “Which is better, San Francisco or Los Angeles?” Questions may also include video, audio, and image files as the main content of the question. For example, a questioning user 105 may submit a question that includes an image of a bird and the text “What kind of bird is this?” Another example may include a questioning user 105 who wants feedback on a musical performance and uploads a video or audio file and asks the polling question, “Should I perform this song for my senior recital?” Questions may be asked which prompt users to answer more than once. For example, in the embodiment of FIG. 3, the question asked by questioning user John Smith 305 is “What are your favorite restaurants in San Francisco?” 300.

Question interface 140 may allow a questioning user 105 to submit one or more potential answers to a submitted question. For example, a question user 105 may ask “What is your favorite beach in Northern California?” and may include the potential answers “Stinson,” “Manresa,” and “Pacifica.” Question interface 140 may allow questioning user 105 to allow other users to submit their own answers, may allow questioning user 105 to restrict answers to those submitted by questioning user 105, or may allow questioning user 105 to allow a mix of questioning user-submitted answers and user-submitted answers.

Question interface 140 may allow a questioning user 105 to select which social networking system users can view and/or answer questions. For example, questioning user 105 may select a subset of social networking system users who can view and answer a question, such as the friends of questioning user 105, members of a network or group, or any other subset of users selected by questioning user 105. In one embodiment, questions asked by questioning user 105 are visible to all users of the social networking system 100. In one embodiment, unless a questioning user 105 restricts who can view and answer a question, question interface 140 makes the question available to all users of the social networking system 100 by default.

Question interface 140 may include the functionality to enable a questioning user 105 to “tag” other users in a question. Tagging users in a question may result in the tagged users being notified of the question, and may result in the names of the tagged users being displayed in conjunction with the question. Tagging a user in a question may also result in the questioning user 105 being notified when the tagged user answers the question. Tagging users in a question may cause the users to “follow” a question. Question interface 140 may provide an interface for tagging users in a question. In the embodiment of FIG. 3, question interface 140 provides “ask friends” button 330.

Question interface 140 may also include the functionality to allow users to follow questions. In the embodiment of FIG. 3, question interface 140 may provide a “follow” button 335 that when clicked allows a viewing user 125 to follow question 300. Following a question may allow new question activity (such as new answers, new votes, new communications, etc.) to be automatically pushed to a following user's newsfeed on the social networking system 100. Users following a question may be displayed in question interface 140. For example, in the embodiment of FIG. 3, pictures of users 310 (user b, user e, user f, and user n) are displayed as following the question 300.

Question interface 140 may allow a questioning user 105 to set an expiration date for questions, after which question interface 140 may remove the question from social networking system 100, or may prevent the question from being voted on or viewed by users. In one embodiment, question interface 140 may automatically assign a question an expiration date. Alternatively, question interface 140 may allow questions to never expire.

### Structured Questions

Questions may be associated with social networking system objects in a variety of ways. The question interface 140 may allow users to tag question terms with social networking system objects within a question entry field. When a questioning user 105 enters a question in a question entry field, the question interface 140 may prompt the questioning user 105 to select objects to associate with one or more of the question terms. The question interface 140 may display one or more candidate objects determined to potentially be relevant to one or more of the question terms, and the questioning user 105 may select one of the displayed objects, thereby associating the selected object with the question term associated with displayed object.

Any suitable method may be used to determine whether or not an object is potentially relevant to a question term. In one embodiment, the question interface 140 identifies objects with common keywords with a question term. For example, the question term “California” may be determined to be potentially relevant to the objects “California (state),” “California Bears (Football team),” and “University of California.” Alternatively, the question interface 140 may identify candidate objects based on the context of the question term, such as terms around the question term, the identity of the questioning user 105, and any information associated with the questioning user 105, such as information entered by the questioning user 105 in the questioning user's profile page. Once candidate objects are identified, the candidate objects are displayed to the questioning user 105 in a drop-down menu or other interface. In addition, users other than the questioning user 105, such as viewing users 125, may be prompted to tag question terms to social networking system objects.

In addition to displaying candidate objects to a questioning user 105 for selection, the question interface 140 may automatically associate question terms with social networking system objects. In one embodiment, if a question interface 140 determines with a threshold amount of confidence that a question term is associated with a social networking system object, the question interface 140 tags the question term with the object. Additional methods for identifying candidate objects are discussed in the context of identifying objects potentially related to status messages in U.S. patent application Ser. No. 13,167,702, filed Jun. 24, 2011, the contents of which are hereby incorporated by reference in its entirety.

The question interface 140 may allow a questioning user 105 to associate an object with a question term for each question term in a question statement. As used herein, “question statement” refers to the text entered as a question by the questioning user 105. It should be noted that the principles discussed herein apply equally to instances where “question statement” includes answer text, though for the purposes of simplicity, the remainder of the description will be limited to embodiments where an object is associated with a term in the question text. Alternatively, the question interface 140 may restrict the number of question terms that a questioning user 105 may associate with objects to a threshold number of question terms. The question interface 140 may also limit the question terms that can be associated with objects to nouns, proper nouns, or any other subset of speech. The question interface 140 may also utilize predictive text capabilities to detect a question term being entered by a user as the user is entering the term, and to display a list of objects potentially relevant to the partially-entered term.

In the example question interface of FIG. 4, the question phrase “What concert in San Francisco should I see?” is entered in the question field 400. The question interface 140 prompts the questioning user 105 to select an object associated with the question term “San Francisco” by displaying the object “San Francisco, Calif.” 405. In the embodiment of FIG. 4, the questioning user 105 may select the object 405, which would result in the question term “San Francisco” being linked to the social networking system object “San Francisco, Calif.” 405. In other embodiments, the question interface 140 displays multiple objects to a questioning user 105 for tagging one of the displayed objects to a question term.

Associating a question term with an object may cause the question term to be replaced by a link including the question term's text. In the embodiment of FIG. 4, the question term “concert” 410 is associated with an object, for instance manually by the questioning user 105 or automatically by the question interface 140. The question term “concert” 410 appears underlined, and includes an html link for an object related to concerts. Tagging objects in a question may cause a pop up window to display a list of the tagged objects or information related to tagged objects when a viewing user 125 moves a user input over the tagged or linked question terms. Selecting a tagged or linked object may cause a viewing user 125 to be directed to a social networking system page or external web page associated with the object.

In addition to manually and automatically tagging terms in question statements, the question interface 140 may allow users to use question templates to enter questions. The question interface 140 may include any number of question templates in any number of template formats, and may allow users to configure the template formats provided. In one embodiment, a question template includes a question clause and one or more blank spaces representing question nouns. The blank spaces in question templates may allow users to select question terms to be filled into the blank spaces. For example, selecting a blank space in a question template may cause a drop-down menu of question terms to be displayed. A questioning user 105, in response to selecting a question template and selecting question terms for the question template blank spaces, creates a question for display.

In the example of FIG. 4, the question interface 140 provides a question template 415. Although only one question template is displayed in the example of FIG. 4, any number of question templates may be provided by the question interface 140. The question template 415 includes the question clause “what is your favorite” 420, and includes blank spaces 425 and 430, separated by the term “in.” Selecting the blank space 425 causes the drop-down box 435 to be displayed. The drop-down box 435 includes the question terms “restaurant,” “theater,” and so forth. Likewise, selecting the blank space 430 causes the drop-down box 440 to be displayed. The drop-down box 435 includes the question terms “San Francisco,” “San Jose,” and so forth. A questioning user 105 can select a question term associated with each drop-down box to enter a question. For example, selecting “park” and “Berkeley” causes the question “What is your favorite park in Berkeley?” to be displayed by the questioning user 105.

In the embodiment of FIG. 3, the question template 415 of FIG. 4 is used to generate the question “What is your favorite restaurant in San Francisco?” 300. The question terms “restaurant” 302 and “San Francisco” 304 are tagged to objects representing the concept “Restaurants” and the location “San Francisco, Calif.,” respectively.

The question terms displayed in response to selecting a blank space in a question template may be pre-tagged to or pre-associated with objects. In the example of FIG. 4, the question term “restaurant” is associated with the concept object “Restaurants,” and the question term “San Francisco” is associated with the location object “San Francisco, Calif.” Question templates thus allow a question interface 140 to efficiently associate question terms with social networking system objects without requiring questioning users to tag question terms manually and without requiring the question interface 140 to select an object to associate with a question term automatically, a process subject to error.

In one embodiment, a question interface 140 allows users to enter their own question terms in template blank spaces. In such an embodiment, the question interface 140 may prompt a user to specify an object associated with a manually entered term, or the question interface 140 may use the question terms selected for other blank spaces, question context information, and questioning user context information to infer the meaning and automatically tag an entered question term.

The question interface 140 selects template question terms to display to a questioning user 105 in response to the user selecting a blank space based on, for example, question context information or user context information. Information associated with the user may include user profile or account information, demographic or biographic information, or any other information associated with the user. In the example of FIG. 4, a question interface 140 may use location information associated with a user to determine which question terms to display in the drop-down box 440. For example, if the question interface determines that a user is located in San Bruno, Calif., the cities “San Francisco,” “San Jose,” and the like are displayed in the drop-down box 440. Alternatively, if the question interface determines that a user is located in Redmond, Wash., the cities “Seattle,” “Tacoma,” and the like are displayed in the drop-down box 440. Alternatively, the question interface 140 may select template question terms to display to a questioning user 105 based on questions asked by friends of the questioning user 105.

A question interface 140 may additionally display sample questions to a user, allowing a questioning user 105 to select a question for display. The sample questions provided by the question interface 140 include question terms that are pre-tagged to or pre-associated with objects. In the embodiment of FIG. 4, the sample questions 450 “What is your favorite baseball team?” “What is your favorite movie?” and so forth are provided. The underlined terms “baseball team,” “movie,” and so forth are associated with objects. Providing sample questions efficiently allows questions selected by a questioning user 105 to be associated with objects. Questions provided by the question interface 140 as sample questions may be sponsored by entities, such as companies, politicians, and the like, in order to increase the likelihood that the sponsored questions will be selected by social networking system users. In such instances, the sponsoring entity may be retrieve answer data associated with sponsored questions, beneficially providing the sponsoring entity with data reflecting preferences of answering users 110.

### Answer Interface

Answering users 110 of the social networking system 100 may use answer interface 145 to answer a question asked by a questioning user 105 of social networking system 100. Using the answer interface 145, answering users 110 may respond to the question using text, HTML, video, audio, and any other communication delivery mechanisms. Although viewing users 125 are shown in FIG. 1 to be coupled to newsfeed module 170, viewing users 125 may view questions and/or answers through question interface 140, answer interface 145, or any other suitable social networking system interface. Further, the term “viewing users” as used herein describes users who request to view or are currently viewing a particular question, and who may or may not answer the particular question, or who may have already answered the question. Thus, answering users 110 and viewing users 125 are not mutually exclusive.

The answer interface 145 may be graphically rendered on the social networking system 100 in various locations. The answer interface 145 may be coupled to or displayed in conjunction with the question interface 140. For example, in the event of a dedicated social networking system question and answer service page, recently submitted questions may be displayed, each displayed question having the functionality to accept and display answers from social networking system users. Likewise, for a question that appears in a user's news feed, the answer interface 145 may be displayed immediately below the question, or may not be displayed until a “display answers” button or link is selected.

The answer interface 145 may comprise a field which allows viewing users 125 to submit an answer to an associated question. For example, in the embodiment of FIG. 3, field 315 allows a viewing user 125 to type an answer to the question “What are your favorite restaurants in San Francisco?” Submitted answers may be saved, displayed to and selected by future viewing users 125. Answer interface 145 may also comprise a series of potential answers submitted by questioning user 105 or other answering users 110 which a viewing user 125 can vote on using, for example, buttons associated with each answer. In the embodiment of FIG. 3, answers 320 are displayed, each containing a button which when selected allows a viewing user 125 to vote on one or more of answers 320. For example, if a viewing user 125 wanted to vote for the answer “Boogaloos,” the viewing user 125 would select button 325. In one embodiment, answers are recommended to questioning and/or answering users based on objects associated with the question.

The answer interface 145 may display the answers and votes of other answering users 110. Answers may be displayed in text fields, graphical bubbles, text boxes, or any suitable format, and the number of answers displayed in the answer interface 145 may be limited to an answer threshold. In the embodiment of FIG. 3, five answers are displayed in text boxes 345, namely “Foreign Cinema,” “Rosamunde Sausage Grill,” and the like. In instances where the number of displayed answers is limited, an interface may be provided to display additional answers. In the embodiment of FIG. 3, button 340 may be selected, and additional answers may be displayed in response.

The answer interface 145 may display additional answer data, such as the number or percentage of votes each answer has received. In one embodiment, displaying answer data comprises textually displaying a number or percentage of votes in conjunction with, over or next to each displayed answer. In one embodiment, displaying answer data comprises graphically representing the number or percentage of votes. In the example of FIG. 3, the text box 345 of each answer is shaded 350 according to the proportion of total users that have selected the answer. In one embodiment, instead of displaying all answer data, only a particular subset of answer data is displayed, such as the answer data from friends of a viewing user 115.

More than one subset of answer data may be displayed simultaneously. For example, the votes of friends of a viewing user may be textually displayed next to each answer, while the total numbers of votes are graphically displayed over each answer. Any subsets of answer data may be displayed simultaneously, and any method of displaying the subsets of answer data may be used.

The answer interface 145 may organize displayed answers in a variety of ways. Answers may be displayed in the order they are received, or in an order designated by questioning user 105. Answers may also be ordered based on the number of votes they receive, for instance, total votes, or the votes of friends of a viewing user 125. In addition, answers may be organized based on demographic information, such as age, gender, work place, location, hometown, school or any other demographic information of answering users 110. The answer interface 145 may also comprise functionality to toggle between various methods of organizing or displaying answers, such as a button which when selected switches between ordering answers based on total votes of answering users 110 and votes of friends of viewing user 125. In the embodiment of FIG. 3, answers are ordered according to the number of answers from friends 355 of a viewing user.

The answer interface 145 may display a picture of answering users 110 next to each answer. In one embodiment, this picture comprises a profile picture of an answering user 110.

The answer interface 145 may display a picture for each of multiple answering users 110 next to a displayed answer. In the embodiment of FIG. 3, up to five pictures of answering users who are friends of a viewing user are displayed in a row 355 next to each answer. In addition, a button 360 is displayed in conjunction with answers that more than five friends of a viewing user have selected that, when selected, displays the pictures of the additional friends.

Similar to the question interface 140, the answer interface 145 may allow users to tag objects in answers. A questioning user 105, answering users 110 or viewing users 125 may tag an answer or an answer term associated with a social networking system object. In the embodiment of FIG. 3, the terms “restaurant” 302 and “San Francisco” 304 are tagged to objects representing the concept “Restaurants” and the location “San Francisco, Calif.” in the question “What is your favorite restaurant in San Francisco?” respectively.

When an answer is entered by a questioning user 105 or an answering user 110, the answering interface 145 may prompt the user to tag the answer or an answer term. For example, the answer interface 145 may display a list of objects potentially relevant to the answer in a drop-down box, and a user may select among the displayed objects to tag the answer to the object. The objects displayed to a user as potentially relevant to an answer may be determined based on objects associated with the question. In such instances, objects potentially representing answers or answer terms may be displayed based on whether the objects are connected to objects tagged in the question. For example, for the question “Where should I vacation?” and an answer “Miami,” the answering interface 145 may determine that the question term “vacation” is associated with an object representing locations, and may display the location object “Miami, Fla.” as an object potentially relevant to the answer “Miami.”

The answer interface 145 may automatically tag objects in answers. In one embodiment, the answer interface 145 parses the text of the question and the text of one or more answers to determine an object related to an answer. In this embodiment, the question “What is your favorite restaurant” and the answer “The Refuge” may be parsed, and an object related to The Refuge Restaurant may be tagged to the answer. Continuing with this embodiment, if an answering user 110 selects the answer “The Refuge” and has previously checked in to The Refuge Restaurant, the location The Refuge Restaurant may be tagged in the answer “The Refuge.” Any information associated with a tagged object may be displayed when a user selects a tagged answer in question interface 140.

In addition, the answer interface 145 may automatically tag objects in answers based on objects associated with the question. In one embodiment, candidate objects are identified for one or more answers as being potentially relevant to the answers. An object among the identified candidate objects may be selected based on the object's relatedness to an object associated with the question. For example, consider the question “What is your favorite band?” where the question term “band” is associated with the object “Band (music group),” and an answer “The Bengals.” The answer interface 145 may identify the objects “The Bengals (music group)” and “Cincinnati Bengals (football team)” as potentially related to the answer “The Bengals” based on a keyword search of social networking system objects. In response, the answer interface 145 may query the social graph and may determine that the nodes representing the objects “Band (music group)” and “The Bengals (music group)” are connected while the objects “Band (music group)” and “Cincinnati Bengals (football team)” are not. Accordingly, the answer interface 145 may select the object “The Bengals (music group)” to automatically tag to the answer “The Bengals.”

The answer interface 145 may also automatically tag objects based on the type of question asked by a questioning user 105. If the type of question asked indicates that only one category of answer can be given, it can be assumed that all answers given can be represented by objects of that category. For example, for a question “Which is better?” or “Which is the best restaurant?” it can be assumed that all answers will be of the same category. In such instances, if an object is tagged in one answer, a similar object may be tagged in another answer. In the example of FIG. 3, for the question 300 “What is your favorite restaurant in San Francisco?” if the answer “Foreign Cinema” is tagged with the object “Foreign Cinema (San Francisco restaurant),” then the answer “Range” may be tagged with an object related to the category “San Francisco restaurant,” such as the object “Range (San Francisco restaurant).”

### System Architecture

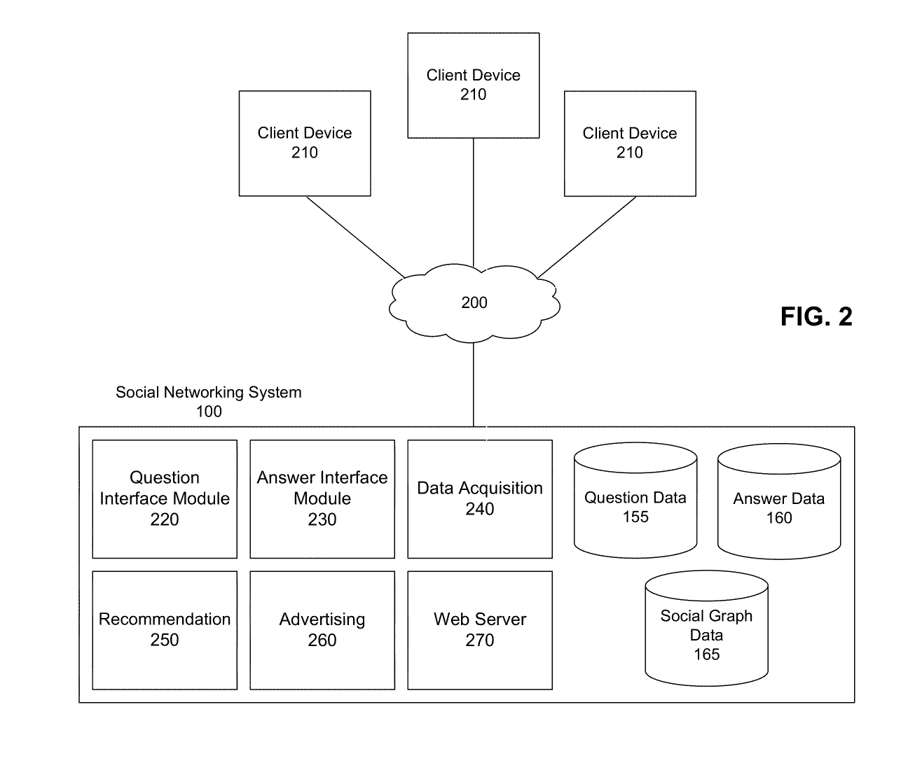

FIG. 2 is a network diagram of a system for associating questions with social networking system objects, in accordance with an embodiment of the invention. The system environment comprises one or more client devices 210, the social networking system 100, and a network 200. In alternative configurations, different and/or additional modules can be included in the system. For example, although only three client devices 210 are displayed, thousands or more client devices 210 may be coupled to social networking system 100 via network 200.

The client devices 210 comprise one or more computing devices that can receive user input and can transmit and receive data via the network 200. In one embodiment, the client device 210 is a conventional computer system executing, for example, a Microsoft Windows-compatible operating system (OS), Apple OS X, and/or a Linux distribution. In another embodiment, the client device 210 can be a device having computer functionality, such as a personal digital assistant (PDA), mobile telephone, smart-phone, etc. The client device 210 is configured to communicate via network 200. The client device 210 can execute an application, for example, a browser application that allows a user of the client device 210 to interact with the social networking system 100. In another embodiment, the client device 210 interacts with the social networking system 100 through an application programming interface (API) that runs on the native operating system of the client device 210, such as iOS and DROID.

In one embodiment, the network 200 uses standard communications technologies and/or protocols. Thus, the network 200 can include links using technologies such as Ethernet, 802.11, worldwide interoperability for microwave access (WiMAX), 3G, digital subscriber line (DSL), etc. Similarly, the networking protocols used on the network 200 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 200 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a question interface module 220, an answer interface module 230, a data acquisition module 240, an advertising module 250, a recommendation module 260, and a web server 270. In addition, the social networking system 100 includes a question data storage module 155, an answer data storage module 160, and a social graph data storage module 165. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 270 links the social networking system 100 via the network 200 to one or more client devices 210; the web server 270 serves web pages, as well as other web-related content, such as Java, Flash, XML, and so forth. The web server 270 may provide the functionality of receiving and routing messages between the social networking system 100 and the client devices 210, for example, instant messages, queued messages (e.g., email), text and SMS (short message service) messages, or messages sent using any other suitable messaging technique. The user can send a request to the web server 270 to upload information, for example, images or videos that are embedded in a question to question data storage module 155. Additionally, the web server 270 may provide API functionality to send data directly to native client device operating systems, such as iOS, DROID, webOS, and RIM.

The web server 270 may also serve web pages including question interfaces and answer interfaces via the network 200 to client devices 210. Alternatively, the web server 270 may also render question interfaces and answer interfaces in native applications on client devices 210. In one embodiment, a web server 270 may render question interfaces on a native platform's operating system, such as iOS or ANDRIOD, to appear as embedded advertisements in native applications.

As discussed above, question data storage module 155 and answer data storage module 160 store data related to question and answers, respectively. This includes but is not limited to the contents of questions and answers, the identities of questioning users 105 and answering users 110, the identity of objects tagged in questions and answers, and any other information related to questions or answers. Social graph data storage module 165 may store any information related in any way to social networking system objects and interactions. In one embodiment, the question data storage module 155, the answer data storage module 160, and the social graph data storage module 165 are implemented in the same storage module. Although not shown in FIG. 2, social networking system may additionally comprise storage modules to store additional information, such as user profile information, user settings, global social networking system settings, or any other information produced, received by or stored within social networking system 100.

The question interface module 220 may comprise means within social networking system 100 to implement question interface 140 as discussed above. Likewise, the answer interface module 230 may comprise means within social networking system 100 to implement answer interface 145 as discussed above. The question interface module 220 and the answer interface module 230 may be further configured to suggest answers to questions based on objects tagged in questions. An object tagged in a question may be identified, and objects associated with the tagged object may be identified based on, for instance, information related to the questioning user 105, to friends of the questioning user, to answering users 110, to viewing users 125, to other answers, or based on any other information related to the question. These identified objects may be presented as potential answers, or potential answers may be presented based on these identified objects. In addition, an explanation of the identified objects may be provided to users.

In the embodiment of FIG. 4, the question 400 “What concert in San Francisco should I see?” is asked, and the question interface 140 provides suggested answers 460. Each suggested answer 460 comprises an object representing a music group and lists an explanation of why the object is being presented to the questioning user 105. For example, the answer “Journey” is presented, the term “Journey” associated with the object “Journey (music group),” and the explanation “listed in profile” is given indicating that “Journey” is listed in the questioning user's profile page, possibly under “Favorite bands” or the like. In addition, information about an upcoming concert in San Francisco is given because of the connection to the concept object “Concert” and the location object “San Francisco, Calif.” which are associated with the question 400. Likewise, the answer “Adele” is given with an explanation that four friends of the questioning user 105 are attending the upcoming Adele concert, and the answer “Dead Kennedys” is given with an explanation that the band Dead Kennedys are from San Francisco. Thus, tagged objects associated with questions can be used to suggest answers by identifying objects connected to the tagged objects, or objects connected to any user associated with the question.

The data acquisition module 240 collects data received from the creation of structured questions. The data acquisition module 240 may associate objects associated with questions with the questioning user 105. In one embodiment, if a questioning user 105 asks a question and tags a question term with an object, the data acquisition module 250 may associate the tagged object with the questioning user 105. In the embodiment of FIG. 4, the term “concert” is tagged in the entered question “What concert in San Francisco should I see?” In this embodiment, an object representing concerts is associated with the questioning user Jane Smith. The data acquisition module

The data acquisition module 240 also collects data received from the answering of structured questions. If an answering user 110 answers a question tagged to an object, the answering user 110 may be associated with the object, and the answering user's answer may be associated with the object. For example, if a question asks “What is your favorite movie?” with the question term “movie” is tagged to an object representing films, and if an answering user 110 answers “Boondock Saints,” then the answering user 110 is associated with the object “Movies (films)” and the answer “Boondock Saints.” Further, if the answer selected by the answering user 110 is itself associated with an object, then the answering user 110 is associated with both the object associated with the question and the object associated with the answer. Continuing with the previous example, if the answer “Boondock Saints” is associated with the object “Boondock Saints (film),” then the answering user 110 is associated with the object “Movies (film)” and “Boondock Saints (film).”

Data collected by the data acquisition module 240 may be used in a variety of contexts. In one embodiment, the advertising module 250 provides advertisements to users based on an association between the user and objects associated with questions. For instance, if a questioning user 105 enters a question via the question interface 140, and if the entered question is tagged with an object, the advertising module 250 may provide an advertisement to the questioning user 105 targeted to the object. In the embodiment of FIG. 4, Jane Smith entered the question “What concert in San Francisco should I see?” and the advertising module 250 displayed the advertisement 455, advertising a Green Day concert in San Francisco. Although the advertisement 455 is displayed in the question interface 140, advertisements targeted to objects tagged in questions may be displayed in any social networking system page displayed to the questioning user 105, or may be displayed outside of the context of the social networking system, for instance a web page using a social networking system plug-in that allows an advertisement to be displayed to the questioning user 105 when the questioning user 105 is viewing an external page. Similarly, advertisements may be displayed to answering users 110 or viewing user 125, based on objects tagged in questions.

Data collected by the data acquisition module 240 may also be used to enhance a user's social networking system experience. In one embodiment, data collected by the data acquisition module 240 for a questioning user 105 or an answering user 110 is sent to the newsfeed of users connected to the questioning user 105 or the answering user 110, highlighting any social networking system objects associated with the question or selected answers. For example, in the embodiment of FIG. 3, the question “What is your favorite restaurant in San Francisco?” by John Smith may appear in the news feeds of users connected to John Smith as the story “John Smith asked a question about San Francisco.” Likewise, a story about a user (“Jill”) that answers the same question may appear in news feeds as “Jill answered a question about San Francisco.”

Data collected by the data acquisition module 240 may be used to auto-populate social networking system profiles or other forms. If a user answers a question associated with an object, the association between the user, the object, and the answer may be used by the social networking system 100 to display information about the user. For example, if a user answers the question “What is your favorite movie?” with the answer “Boondock Saints,” the social networking system 100 may insert or may suggest inserting “Boondock Saints” into the “Favorite movies” section of the user's profile. In one embodiment, a user may answer several questions presented by questioning users 105 or by the social networking system 100, each tagged with an object, and the social networking system 100 may generate profile information for the user based on the answers and the tagged objects.

Data collected by the data acquisition module 240 may also be used by entities interested in survey data. For instance, a surveyor may want to know which movie users of a social networking system are most likely to see. Questions associated with an object representing movies generally may be queried to determine which movies answering users select. Likewise, a surveyor may be interested in which politicians social networking system users are talking about. In these instances and others, an object which a surveyor is interested in may be queried to identify questions which are associated with the object, answers associated with such questions, individuals associated with the questions and answers, or any other information related to the questions.

Data collected by the data acquisition module 240 may also be used to recommend objects to users by the recommendation module 260. In one embodiment, if several friends of a target user ask questions associated with a particular object, the object may be used in making recommendations to the target user. For example, if several friends ask questions involving the location object “San Francisco, Calif.,” other objects associated with the questions, with answers to the questions, or with users associated with the questions may be identified and recommendations may be based on the identified objects. Continuing with this example, if the object “Zuni Café (restaurant)” is identified in answers to questions associated with the object “San Francisco, Calif.,” then if a target user uses location detection functionality to “check in” to a location in or near San Francisco, Calif., the recommendation module 260 may recommend the restaurant “Zuni Café” to the target user. Likewise, if a questioning user 105 asks a question related to San Francisco, Calif., and if the questioning user 105 lists “Rye (cocktail bar in San Francisco)” in the questioning user's profile, then the bar “Rye” may be recommended to a target user by the recommendation module 260 when the target user searches for “bars in SF” using a mobile phone. Thus, the recommendation module 260 may recommend objects identified in questions to recommend other objects associated with the questions, answers, users, or any other objects to users.

Object tagging module 270 allows a questioning user 105, an answering user 110, or a viewing user 125 to tag users or objects in a question or an answer. In one embodiment, a user tags objects in a question through question interface module 220 and tags objects in an answer through answer interface module 230. In one embodiment, object tagging module 270 tags an object in a question or an answer by identifying an object in social graph data storage module 165, and associating the identified object with a question stored in question data storage module 155 or with an answer stored in answer data storage module 160.

Associating Questions with Social Networking System Objects

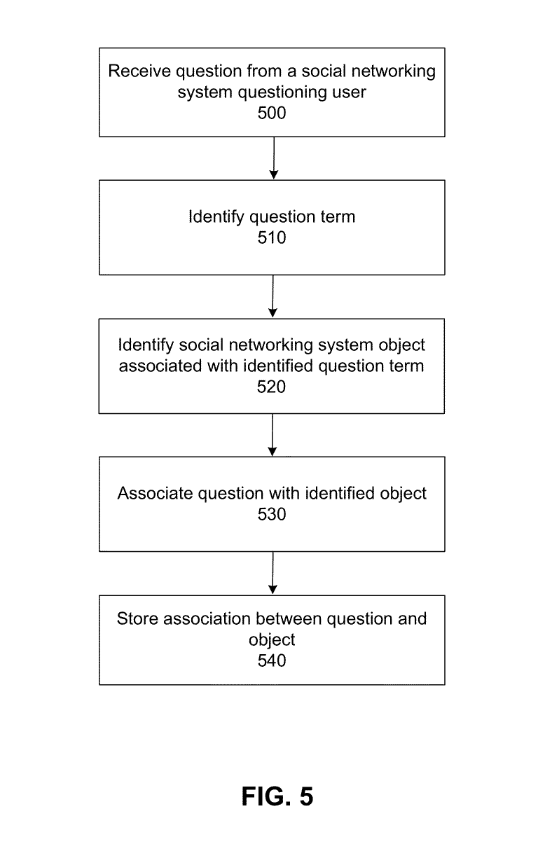

FIG. 5 is a flowchart of a process for associating one or more social networking system objects with a question asked in a social networking system, in accordance with an embodiment of the invention. A question is received 500 at a social networking system from a questioning user. A question term is identified 510, for instance a question word or phrase. The question term may be identified by the questioning user, who may select the term manually. Alternatively, the question term may be identified by the social networking system automatically, for instance by selecting question nouns or noun phrases.

A social networking system object associated with the identified question term is identified 520. The social networking system object may be identified by identifying objects potentially relevant to the identified question term (using, for example, a keyword search of question term text among social networking system objects), and by displaying the identified objects to the questioning user for manual selection of the object which best represents the identified question term. Alternatively, the social networking system may automatically identify an object associated with the identified question term using the context of the identified term, such as the other terms in the question, information associated with the questioning user, or any other information related to the identified question term.

The identified object is associated 530 with the received question, and this association is stored 540 for subsequent use. The stored association may be used to auto-populate a user's page in a social networking system, or to provide suggested information for display in a social networking system page. The stored association may also be used to generate stories for display in social networking system newsfeeds or other social networking system interfaces. In addition, the stored association may be used to target advertising towards users associated with the received question. Objects may be recommended to social networking system users based on the stored association, for instance objects associated with particular locations. The stored association may be used to automatically tag objects in answers, or to provide suggested answers to the questioning user or to answering users. Finally, the stored association may be queried to identify answer information and other information associated with the object.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving a question at a social networking system from a questioning user;
identifying a question term in the received question;
identifying a social networking system object associated with the identified question term;
associating the received question with the identified object; and
storing the association between the received question and the identified object.

2. The method of claim 1, wherein the question is received at a dedicated social networking system question interface.

3. The method of claim 1, wherein identifying a question term comprises receiving a selection of a question term by the questioning user.

4. The method of claim 1, wherein identifying a question term comprises the automatic identification of a question term by the social networking system.

5. The method of claim 1, wherein the identified question term comprises a noun.

6. The method of claim 1, wherein identifying a social networking system object comprises:
identifying one or more objects relevant to the identified question term;
displaying the identified objects to the questioning user; and
receiving a selection of a displayed identified object from the questioning user.

7. The method of claim 6, wherein identifying one or more objects relevant to the identified question term comprises performing a keyword search on information related to a plurality objects using text of the question term.

8. The method of claim 6, wherein displaying the identified objects to the questioning user comprises displaying the objects in a drop-down menu.

9. The method of claim 1, wherein identifying a social networking system object comprises the automatic identification of an object by the social networking system.

10. The method of claim 9, wherein the social networking system automatically identifies objects based on the context of the identified question term in the received question.

11. The method of claim 9, wherein the social networking system automatically identifies objects based on information related to the questioning user.

12. The method of claim 1, wherein receiving a question comprises:
presenting a template question to the questioning user, the template question comprising an empty question term;
receiving a selection of the template question from the questioning user;
presenting a plurality of question terms to the questioning user, each of the plurality of question terms associated with a social networking system object;
receiving a selection of a presented question term from the questioning user; and
replacing the template question's empty question term with the selected question term.

13. The method of claim 12, wherein the identified question term comprises the selected question term, and wherein the identified social networking system object comprises the object associated with the selected question term.

14. The method of claim 1, wherein receiving a question comprises:
presenting a plurality of sample questions to the questioning user, each of the plurality of sample questions associated with a highlighted question term, each highlighted question term associated with a social networking system object; and
receiving a selection of a presented sample question from the questioning user.

15. The method of claim 14, wherein the identified question term comprises the highlighted question term associated with the selected sample question, and wherein the identified social networking system object comprises the object associated with the selected sample question.

16. The method of claim 1, wherein the stored association is used to collect information about answering users who answer the received question.

17. The method of claim 16, wherein the collected information is used to auto-populate social networking system forms associated with the answering users.

18. The method of claim 17, further comprising:
presenting the collected information for selection to an answering user;
receiving a selection of the presented information to display the presented information from the answering user; and
displaying the selected information.

19. The method of claim 1, wherein the stored association is used to generate a social networking system story.

20. The method of claim 19, wherein the generated story comprises the received question, the object associated with the received question, and an action taken by a user associated with the received question.

21. The method of claim 1, wherein the stored association is used to recommend an object to a user.

22. The method of claim 21, wherein recommend an object to a user comprises:
identifying an association between the user and between the object of the stored association;
identifying a second object associated with the stored association; and
displaying the second object to the user.

23. The method of claim 1, wherein the stored association is used to collect information associated with the object of the stored association from users that answer the received question.

24. The method of claim 1, wherein the stored association is used to target advertising to a user.

25. The method of claim 24, wherein targeting advertising to a user comprises:
identifying a user associated with the question;
identifying an advertisement associated with the object of the stored association; and
displaying the identified advertisement to identified user.

26. The method of claim 1, wherein the stored association is used to identify a social networking system object associated with an answer to the received question.

27. The method of claim 26, wherein identifying a social networking system object associated with an answer comprises:
identifying an answer term within the answer;
identifying a plurality of social networking system objects relevant to the identified answer term; and
selecting the identified object relevant to the answer term based on the object of the stored association.

28. The method of claim 1, wherein the stored association is used to recommend an answer to the questioning user.

29. The method of claim 28, wherein recommending an answer to the questioning user comprises:
identifying an object associated with the object of the stored association; and
presenting the identified object to the questioning user.

30. A computer-implemented method comprising:
receiving a question at a social networking system from a questioning user;
receiving a selection of a question term in the received question from the questioning user;
displaying a list of candidate objects, the candidate objects comprising social networking system objects determined to be relevant to the selected question term;
receiving a selection of a candidate object from the list of candidate objects from the questioning user;
associating the received question with the identified object; and
using the association to retrieve additional information about the questioning user.
